(19) United States
(12) Patent Application Publication
(10) Pub. No.: US 2026/0170293 A1
(43) Pub. Date: Jun. 18, 2026

(54) CONNECTED MODEL FRAMEWORK FOR FORECASTING CAUSAL PREDICTIONS

(71) Applicant: Optum Services (Ireland) Limited, Dublin (IE)

(72) Inventors: Breanndán O Conchuir, Kerry (IE); James McNair Sloan, Bathgate (GB); Matthew Robinson, Greystones (GB); Saurabh Goel, Naas (IE)

(21) Appl. No.: 18/980,308

(22) Filed: Dec. 13, 2024

(51) Int. Cl. G06N 3/042; G06N 3/08

(52) U.S. Cl. CPC G06N 3/042; G06N 3/08

(57) ABSTRACT

Various embodiments of the present disclosure provide a technique for forecasting causal predictions that improves the functionality of a computer in various aspects. The techniques comprise receiving a historical sequence for a time-based prediction, generating, by a connected model framework, a first time-based output for a first time position in a prediction sequence for the time-based prediction, generating, using a directed acyclic graph, an output modification for a second time position in the prediction sequence; generating, using a machine learning model, a second time-based output for the second time position in the prediction sequence based on the output modification and the first time-based output, and initiating performance of a prediction-based action based on the prediction sequence.

### BACKGROUND

In various domains, causal modeling is used to make inferences based on defined causal relationships. The defined causal relationships provide explainability to inferences made by the causal model and ground the model's inferences in reliable sources. However, traditional causal modeling approaches have several disadvantages that prevent their full automation within a computing environment. For example, inferences made through causal models are limited to static correlations in statistical data as causal models are incapable of forecasting or learning new relationships from new data. Moreover, causal models require, as input, various dependent variables and are thus traditionally limited to a single point in time in which these variables are available.

In other domains, graph-based machine learning models, such as graph neural networks (GNNs), may be used to make inferences based on learned relationships between entities modeled within the graph. Such approaches are traditionally specialized for a particular inference and require sufficient training and/or input data to achieve desired levels of accuracy for their particular inference. Thus, while capable of adapting to correlations in new data, traditional graph-based machine learning models are ineffective for many inferences due to a lack of training and/or input data and their specialized nature make them impractical for instances with a degree of optionality, such as forecasting the impact of different mitigation actions within a population.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of an example machine learning configuration in accordance with some embodiments of the present disclosure.

FIG. 5 depicts a dataflow diagram of an example causal directed acyclic graph (DAG) in accordance with some embodiments of the present disclosure.

FIG. 6 depicts a dataflow diagram of an example connected model framework in accordance with some embodiments of the present disclosure.

FIG. 7 depicts a flowchart diagram of a process for causing a mitigating action to be performed in accordance with some embodiments of the present disclosure.

### DETAILED DESCRIPTION

Various embodiments of the present disclosure provide a connected model framework that improves a computer's functionality with respect to various inference tasks by uniquely coupling two, traditionally distinct model architectures into a single forecasting unit. To do so, some embodiments of the present disclosure provide a coupling mechanism that provides a feedback loop between a graph-based machine learning model and a series of causal model (e.g., causal DAGs). For example, the coupling mechanism may couple an input feature within the nodes of the graph machine learning model with an intermediate node of the causal model. By doing so, the coupling mechanism may create a continuous feed forward design in which a graph machine learning model may forecast unknown parameters for a series of causal models, while the causal models integrate different sets of known correlations to implement optional future scenarios. In this way, the connected model framework of the present disclosure provides an improved modeling framework that simultaneously addresses technical challenges with both traditional graph machine learning models and traditional causal modeling approaches to allow for improved inference capabilities. This, in turn, may enable new inferences that address optional scenarios traditionally outside the scope of machine learning.

More particularly, the connected model framework of the present disclosure may comprise a graph-based machine learning model with nodes and edges that model various characteristics at a particular time position. In some examples, up to each node within the graph may comprise a sequence of time-varying elements. The graph-based machine learning model may be trained to forecast a new time-varying element within up to each node based on its characteristics and/or connections within the graph. During operation, the time-varying element associated with up to each node in the graph may be updated to iteratively forecast a new prediction (e.g., a time-based output) for a new time point in a prediction sequence. Thus, a prediction sequence within up to each node of the graph machine learning model may serve as an input to future forecasts allowing the graph machine learning model to forecast a series of time-varying elements to any future time point. In some embodiments, the connected model framework may connect the time-varying elements of a prediction sequence to a causal model that may apply a set of relationships to produce a modification to a time-based output before and/or after the time-based output is added as a time-varying element of the prediction sequence. In this manner, a causal model may provide feedback to the graph machine learning model to incorporate relationships defined within the causal model into the future predictions of the graph machine learning model. By doing so, some embodiments of the present disclosure simultaneously improve the performance of both the causal model and the graph machine learning model through cross feedback.

In addition, or alternatively, the connected model framework may introduce optionality into the graph machine learning model by using a set of causal models to model different optional scenarios that may impact the future state of the time-based prediction. For example, the causal model may be associated with a mitigating action that may impact a time-varying element at a particular time if implemented within the real world. To simulate the interaction between the mitigation action and future time-varying element forecasts (e.g., time-based outputs), the coupling mechanism of the present disclosure may feed the forecasts from the graph machine learning model as a time-dependent variable to an intermediate node of the causal model. The causal model generates a modification to the model prediction and updates the time-varying elements of the graph machine learning model based on the modification to introduce optionality into a traditionally set architecture. By doing so, some embodiments of the present disclosure enable the use of a set of different causal models, each associated with a different actions, to model the effect of different actions on a time-varying element at any point in the future.

Examples of technologically advantageous embodiments of the present disclosure (i) provide a unique arrangement of computing models, a graph machine learning model and causal model, that improves the accuracy of computer simulations, (ii) modify computing models, such as a graph machine learning model and causal model, to produce a dual model that is more powerful (e.g., in terms of accuracy and optionality) than either of its counterparts, among other aspects of the present disclosure. Other technical improvements and advantages may be realized by one of ordinary skill in the art.

### I. OVERVIEW OF EMBODIMENTS

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

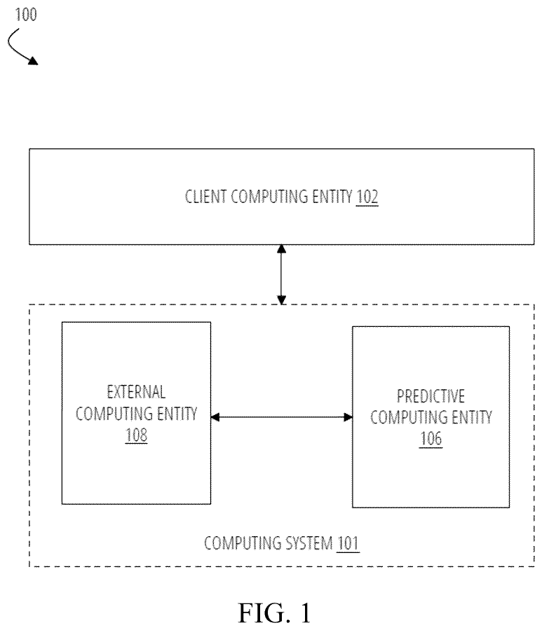

FIG. 1 depicts a block diagram of an example architecture 100 in accordance with some embodiments of the present disclosure. The architecture 100 comprises a computing system 101 configured to receive a historical sequence related to a time-based prediction from client computing entities 102, apply the historical sequence to a connected model framework comprising a machine learning model and a DAG, and initiate the performance of a prediction-based action at one or more of the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate candidate outputs, candidate output scores, and/or other machine learned outputs. The models may be adapted to generate a prediction sequence based on a historical sequence and interconnection characteristics related to a time-based prediction. Some techniques of the present disclosure may adapt traditional models to a cohesive framework, such as the modular model ensemble, for more efficiently generating the prediction sequence based on a historical sequence and interconnection characteristics.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured receive historical sequences related to a time-based prediction, apply the historical sequence to a connected model framework, and initiate the performance of a prediction-based action at one or more of the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., prediction sequence generation) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as a historical sequence, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

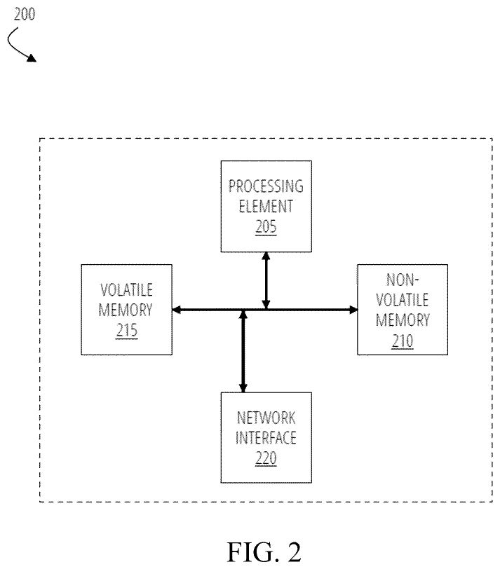

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

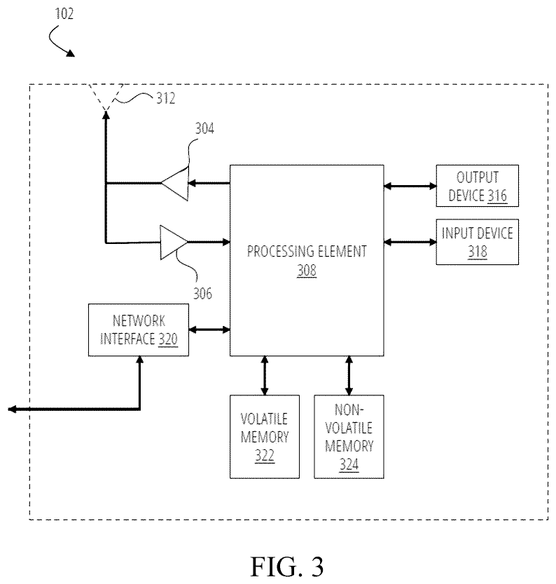

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLE SYSTEM OPERATIONS

As indicated, various embodiments of the present disclosure make important technical contributions to improve predictions of time-varying elements of networked locations in response to a mitigating action. In particular, systems and methods are disclosed herein that implement a connected model framework comprising a causal model coupled with a graph machine learning model to improve a prediction sequence of the time-varying element. By doing so, the connected model framework seamlessly integrates a machine learning model based on a historical sequence and statistics, with a causal model that defines statistical relationships within an environment. This, in turn, may improve the functionality of a computer with respect to various computing tasks, including machine learning training, forecasting accuracy, action selection, and the like.

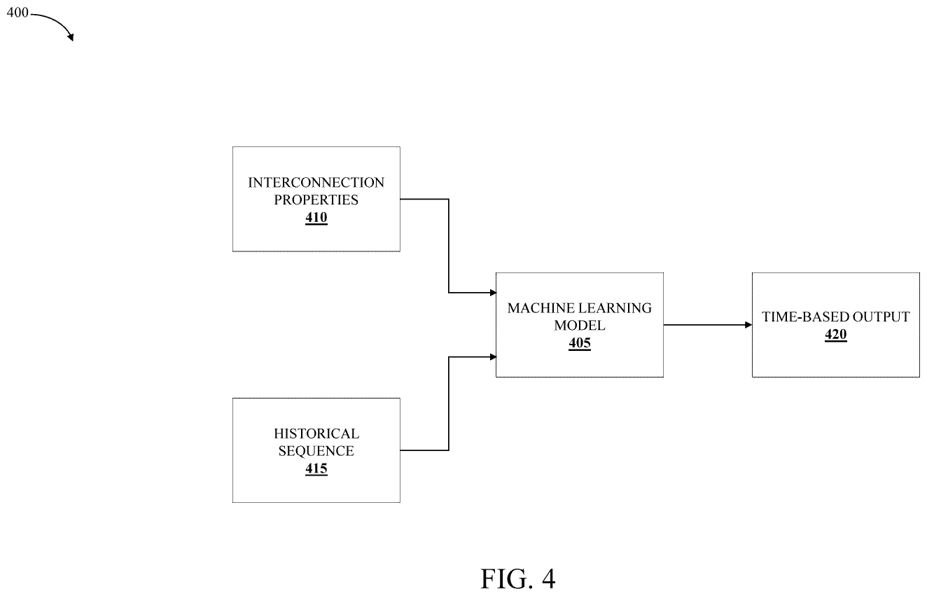

FIG. 4 depicts a dataflow diagram 400 of an example machine learning model 405 in accordance with some embodiments of the present disclosure. As depicted, the machine learning model 405 may be configured using one or more inputs, such as interconnection properties 410 and/or historical sequences 415, to model a time-varying element within a set of at least partially connected, networked locations. The networked locations, and/or the time-varying element thereof, may depend on a domain such that the machine learning model 405 may be adaptable to different, domain-specific predictions. For example, for a clinical domain, the networked locations may represent a set of geographic locations and/or the time-varying element may represent a number of cases of a particular infectious disease at up to each of the set of geographic locations. As another example, for a computer security domain, the networked locations may represent computing environments (e.g., servers, user device) and/or the time-varying element may represent a number of detections of a particular computer virus.

In some embodiments, the time-varying element changes over time based on the characteristics of the networked and/or the networked location interconnected (e.g., directly or indirectly) thereto. To account for the timing and/or interconnectivity influences on a time-varying element, the machine learning model 405 may receive a historical sequence 415 and/or interconnection properties 410 for up to each networked location in a modeled environment.

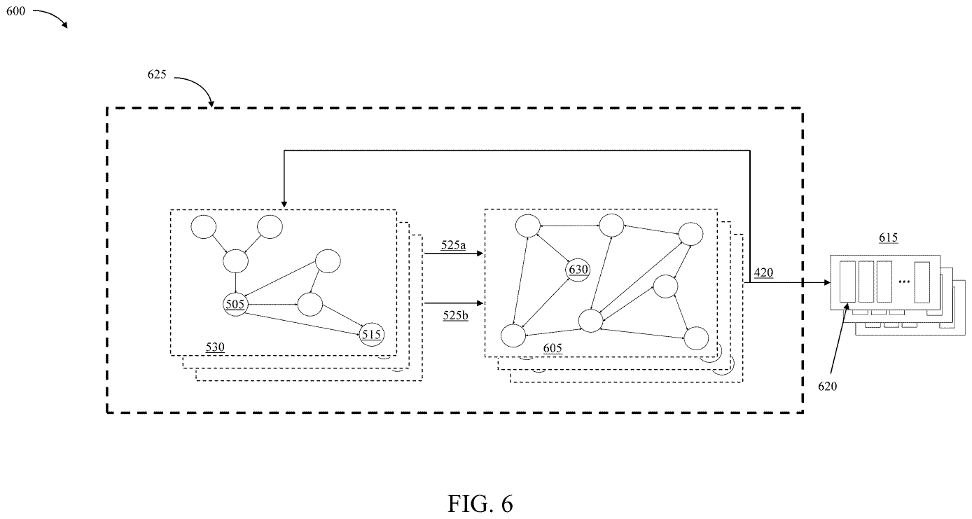

In some embodiments, the machine learning model 405 may generate a time-based output 420 for up to each of the networked locations based on the interconnection properties 410 and/or the historical sequence 415 received for the networked location. The time-based output 420, for example, may comprise a predicted value of the time-varying element at the networked location at a future time position subsequent to the historical sequence 415. For example, given a historical sequence 415 (e.g., a past week) of the time-varying element at a networked location and/or the interconnection properties 410, the machine learning model 405 may generate a predicted time-varying element at a future time (e.g., tomorrow). In order to generate a prediction sequence (e.g., as further described in relation to FIG. 6), the machine learning model 405 may add the time-based output to the historical sequence 415 and iteratively generate a new, time-based output based on the update historical sequence 415. In this manner, a computing system 101, using the machine learning model 405, may predict a sequence of time-based outputs 420 for successive time positions. To enable the machine learning model 405 to improve over time, the predicted time-varying elements within the historical sequence 415 may be updated based on one or more verification outputs. The verification outputs, for example, may be utilized to correct discrepancies in the historical sequence 415 and observed outcomes relative to the time-varying element associated with a particular networked location.

In some embodiments, the computing system 101 receives a historical sequence 415 for a time-based prediction. A time-based prediction, for example, may comprise a target prediction for a connected model framework. A time-based prediction may include any type of prediction category that has a timing element, such as a disease progression prediction in which a disease forecast is made for a future time based on a historical trend of that disease.

In some embodiments, a historical sequence 415 for a time-based prediction comprises a set of historical observations (e.g., time-varying elements) for a time-based prediction. A historical sequence 415, for example, may comprise a set of time-varying elements that respectively correspond to a set of historical time positions. A time-varying elements of the set of time-varying elements may comprise a ground truth for the time-based prediction at a particular historical timepoint. For example, in a disease progression use case, the ground truth may identify a recorded infection rate of a particular disease at a particular timepoint.

In some examples, a historical sequence 415 comprise a time series data structure, such as a time series database, indexed array, linked like, and/or the like, that stores a set of values (e.g., time-varying elements) in a manner that preserves their temporal relationships. For example, the historical sequence 415 may comprise a set of time-varying elements that are indexed in an order in which they occur in time. A first time-varying element at a first position within the historical sequence 415, for example, may temporally precede a second time-varying element at a second position that is subsequent to the first position within the historical sequence 415. In addition, or alternatively, the historical sequence 415 may comprise metadata associated with up to each time-varying element. The metadata, for example, may comprise a timestamp, and/or the like.

In some examples, the computing system 101 may receive a historical sequence 415 for up to each of a set of networked locations. The computing system 101 may configure the machine learning model 405 by providing the historical sequence 415 for up to each of the set of networked locations as an input feature. By way of example, the machine leaning model 405 may comprise a set of nodes and edges. In some examples, a node of the set of nodes may correspond to a networked location and the computing system 101 may configure the machine learning model 405 by storing a historical sequence for the networked location within the node.

In some embodiments, the computing system 101 may receive interconnection properties 410 for the time-based prediction. The interconnection properties 410 may comprise any data and/or values representing the interconnectivity of two networked locations. By way of example, the interconnection properties 410 may define a set of interconnection attributes that describe a rate of travel (and/or other attributes) of a connection between two networked location. As an example, an interconnection attribute may comprise interconnecting roads, bridges, subways, trains, and/or the like between two geographical locations. In addition, or alternatively, an interconnection attribute may comprise a rate of travel between the two geographical locations (e.g., via the roads, bridges, subways, trains, and/or the like). As another example, an interconnection attribute may comprise interconnecting network sockets, wireless connections, wired connections, and/or the like. In this manner, regardless of domain, the interconnection properties 410 may define a speed, bandwidth, type of connection, and/or rate of travel between two networked locations of any type.

In some examples, the computing system 101 may receive interconnection properties 410 for up to each of a set of networked locations. The computing system 101 may configure the machine learning model 405 by providing the interconnection properties 410 for up to each of the set of networked locations as an input feature. By way of example, the machine leaning model 405 may comprise a set of nodes and edges. In some examples, a node of the set of nodes may correspond to a networked location and the computing system 101 may configure the machine learning model 405 by storing the interconnection properties 410 as weighted edges between the nodes. For example, the computing system 101 may preprocess the interconnection properties, normalize the interconnection attributes thereof, and generate weighted edges reflective of the interconnection attributes. For example, the weight value of a weighted edge may be based on a relative rate of travel between two network locations corresponding to the nodes connected by a respective edge.

By way of example, the edges of the machine learning model 405 may represent the throughput (e.g. a rate at which information, materials, or entities successfully pass from one node to another in a networked system over a particular time period) between two nodes. In the context of communication between network nodes, throughput may refer to the amount of data transmitted successfully per unit time. In the context of disease transmission, throughput may refer to the number of infections transmitted between geographic locations over a specific time frame. In some examples, the computing system 101 (and/or a portion thereof) receives an interconnection attribute associated with a throughput between the networked location and a connected network location. The computing system 101 may initialize an edge weight of an edge between the input node and the connected node based on the interconnection attribute.

In some embodiments, the machine learning model 405 comprises a predictive model that is configured to generate a time-based output 420 for a time-based prediction based on the historical sequence 415, the interconnection properties 410, and/or other predictive features for up to each of a set of networked locations within a modeled environment. The machine learning model 405 may comprise a graph-based model, such as a graph neural network (GNN), a graph convolutional network (GCN), graph recurrent neural network (GRNN), and/or the like. A graph-based model, for example, may represent complex relationships within the modeled environment, as a set of nodes (e.g., vertices) and edges (e.g., connections between nodes). The graph-based model may be trained to learn meaningful embeddings for up to each node by aggregating information from its neighbors, its connecting edges, and/or itself. By way of example, the graph-based model may be trained, using backpropagation of errors as optimized via gradient descent, to improve a node-level loss function (e.g., cross-entropy loss) that measures a predictive accuracy of the graph-based model with respect to a time-based output 420. The graph-based model, for example, may be trained using a supervised training technique (e.g., using the historical sequences 415 as training data), an unsupervised training technique, such as a reconstruction loss function, and/or semi-supervised or reinforcement learning techniques.

In some embodiments, the computing system 101 configures the machine learning model 405 for a time-based prediction by generating a node for up to each of a set of networked locations. The computing system 101 may store attributes for a networked location as input features within a corresponding node. For instance, the computing system 101 may store a historical sequence 415 as an input feature. In addition, or alternatively, the computing system 101 may generate an edge for up to each of a set of interconnection attributes defined by the interconnection properties. For example, the computing system 101 may generate an edge between two nodes that respectively correspond to two connected networked locations. In some examples, the computing system 101 may assign an initial weight to up to each of a set of edges based on a strength (e.g., frequency of travel) of an interconnection attribute. In this manner, the machine learning model 405 may provide a structured representation of a set of historical sequences 415 and interconnection properties 410 of a modeled environment.

In some embodiments, a node of the machine learning model 405 corresponds to a networked location within a modeled environment. The networked location, for example, may depend on a prediction domain. Examples may comprise a geographic region, a computer, and/or any other physical and/or digital environment. By way of example, in a disease progression use case, the networked location may comprise a geographic region with a historical disease rate (e.g., historical sequence 415). In some examples, the node may represent a set of attributes for a networked location, such as geographical coordinates, population statistics, connectivity information (e.g., as defined by the interconnection properties 410), historical sequence 415, and/or the like.

In some examples, up to each node of the machine learning model 405 may comprise historical sequence 415 and/or a prediction sequence of time-varying elements for a time-based prediction. For example, the historical sequence 415 of time-varying elements may comprise a historical sequence of time-varying elements that occur at one or more time points preceding a first time-based output of the machine learning model 405. The prediction sequence may comprise a forecasted sequence of time-varying elements that comprise the first time-based output and/or one or more additional time-based outputs for future times subsequent to the first time-based output.

In some embodiments, a weighted edge that connects a node pair of the machine learning model 405 corresponds to an interconnection attribute between two networked locations respectively corresponding to the node pair. The weighted edge, for example, may identify a network connection between the two nodes of the node pair. In some examples, the weighted edge may comprise an edge weight that may be based on a throughput of the network connection. By way of example, in a disease progression use case, the edge may correspond to one or more travel routes between two geographic regions and the edge weight may correspond to a level of travel between the two geographic regions. In this manner, the nodes and edges of the machine learning model 405 may represent interconnected systems of networked locations where the state and/or behavior of one location may influence others. In epidemiological models, for example, nodes represent geographic regions whose disease rates may be influenced by factors, such as population movement between geographic regions. In computational networks, networked locations represent compute resources, servers, or other computing locations whose virus rates may be influenced by factors, such as message transfers between wirelessly connected systems.

In some embodiments, the computing system 101 generates, using the machine learning model 405, a time-based output 420 for up to each of a set of networked locations. The time-based output 420, for example, may comprise a prediction for a particular future timepoint. In some examples, the time-based output 420 may be specific to a particular node (e.g., networked location) within the machine learning model 405. In this regard, the machine learning model 405 may generate a time-based output 420 for up to each of the nodes within the machine learning model 405 and at each timepoint in a prediction sequence.

A time-based output 420, for example, may comprise a predicted value and/or associated metadata, such as the prediction timepoint, confidence intervals, probability distributions, and/or the like. The generation of time-based outputs 420 may involve a complex computational process. By way of example, the machine learning model 405 may implement one or more message passing algorithms where information is propagated through a graph structure before being aggregated, at up to each node, to produce the final output. These computations may be optimized using techniques such as sparse matrix operations, graph partitioning for large-scale graphs, and/or the like.

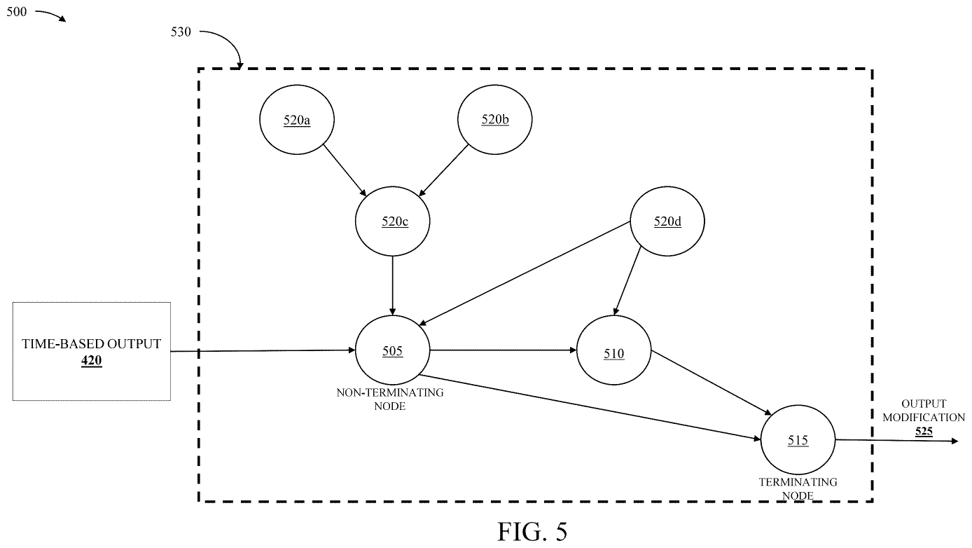

In some examples, time-based outputs 420 may be used in various applications to inform decision-making. For example, in a disease forecasting scenario, time-based outputs 420 for different geographic regions (e.g., networked locations) may guide resource allocation and/or intervention strategies. In computing domain, time-based outputs 420 for a computer environment may guide computer performance actions. In some examples, the time-based outputs 420 may be used as inputs for downstream tasks and/or models (e.g., a causal DAG as further described in relation to FIG. 5), enabling hierarchical or cascading prediction systems.

FIG. 5 depicts a dataflow diagram 500 of an example causal DAG 530 in accordance with some embodiments of the present disclosure. As shown in the dataflow diagram 500, the causal DAG 530 comprises a plurality of nodes 520a-520d, comprising at least a non-terminating node 505, a causal intervention node 510, and/or a terminating node 515. The causal DAG 530 models an output modification 525 to a machine learning model based on the time-based output 420 from a previous timepoint of the machine learning model. Up to each causal DAG 530 may be associated with a mitigating action enabled by the causal intervention node 510 and designed to affect a time-varying element of a node of a machine learning model. The causal DAG 530 may be constructed based on the input of subject matter experts to estimate the affect the various factors related to the mitigating action associated with the causal DAG 530 may have on the time-varying element. Up to each node 520a-520d, 505, 510, 515 may model a factor which may be deemed important to prediction of the time-varying element. At up to each timepoint, the causal DAG 530 may receive a time-based output 420 from the machine learning model and generate an output modification 525 to adjust the machine learning model based on the mitigating action. In this way, predictions generated by a graph-based machine learning model may be seamlessly integrated with a causal DAG generated in coordination with subject matter experts. Such a seamless integration enables accurate prediction of a time-varying elements in the presence of a mitigating action. Integration of a causal DAG 530 influenced by subject matter experts may be especially useful in new and/or emerging applications. In addition, cross feedback between the causal DAG 530 and the machine learning model may enable simultaneous improvements to the causal DAG 530 and/or the machine learning model during operation.

In some embodiments, the computing system 101 generates, using a causal DAG 530 of the connected model framework, an output modification 525 for a time position in the prediction sequence and based on the time-based output 420. In some embodiments, the causal DAG 530 comprises a non-terminating node 505 that corresponds to the time-based output 420 of the machine learning model. In some embodiments, the causal DAG 530 corresponds to a mitigating action of a set of mitigating actions for the time-based prediction and the causal DAG 530 is one of a set of causal DAGs that respectively correspond to the set of mitigating actions.

In some embodiments, a causal DAG 530 comprises a structured data object that comprises a set of nodes and/or directed edges modeling the impact of a particular mitigating action on a time-based prediction (e.g., a time-based output 420 thereof). A causal DAG 530, for example, may be designed by data scientists, policy makers, subject matter experts, and the like. Up to each causal DAG 530 may be associated with a particular mitigating action. In some examples, a causal DAG 530 may comprise a terminating node 515 and/or at least one non-terminating node 505. The non-terminating node 505 may be configured to receive a time-based output 420 of the machine learning model. The terminating node 515, for example, may be associated with a time-based prediction and/or may be configured to generate an output modification 525 to a machine learning model input node and/or corresponding edges based on the associated mitigating action.

In some examples, a causal DAG may comprise a graph data structures that comprises a set of nodes and/or edges. The graph data structure may be realized using adjacency lists, matrices, or specialized graph data structures optimized for DAG operations. In memory, DAGs may be stored as objects with pointers and/or references representing the directed edges between nodes. In some examples, a causal DAG may be used to model causal relationships and/or dependencies in complex systems. In the context of time-based predictions and mitigating actions, they provide a structured way to represent how interventions propagate through a system to affect outcomes. For example, a DAG may model how closing schools (a mitigating action) affects various intermediate factors before ultimately influencing disease spread rates (e.g., a time-based prediction).

In some examples, the causal DAG 530 may correspond to a mitigating action. A mitigating action, for example, may comprise an action intended to affect change to a target variable value (e.g., time-varying element for a time-based prediction). For example, a mitigating action may be an action taken to reduce the time-varying element at a particular geographic location. An example mitigating action to reduce an infection count in a particular geographic location may be to close an airport, for example.

In some examples, a mitigating action may be implemented in computer systems as parameterized interventions that may be simulated and/or applied within the connected model framework. This may involve data structures representing the action type, target location, or system component, intensity, or duration of the action, and/or expected resource requirements and/or costs. The implementation of mitigating actions may require detailed modeling of the effect of the action across various components of the system. This may comprise direct effects, secondary consequences, and potential unintended outcomes. In complex systems, this might involve coupling the mitigating action model with simulation engines and/or domain-specific models to capture nuanced impacts.

In some examples, a mitigating action may be initiated to proactively influence a trajectory of a system, typically to avoid undesirable outcomes and/or to steer the system towards more favorable states. In the context of disease management, mitigating actions may comprise interventions, such as school closures, mask mandates, vaccination campaigns, and/or the like that are designed to reduce transmission rates and/or severity of infections. The functionality of mitigating actions in predictive modeling extends beyond simple binary interventions. They may be modeled as continuous or multi-dimensional actions with varying intensities and/or combinations.

In some embodiments, the causal DAG 530 is configured to generate an output modification 525 at a terminating node 515. An output modification 525 may comprise any data value representing a predicted change in a time-based output 420 based on particular results of a causal DAG 530 when a particular input is received from the machine learning model. For example, the output modification 525 may represent the reduction in infections if a particular mitigating action is taken.

In some examples, an output modifications 525 may be implemented in computer systems as data structures that encapsulate the predicted change along with relevant metadata. This may comprise the original time-based output 420, the modified output, the associated mitigating action, and/or measures of uncertainty or confidence in the modification. In memory, these may be represented as objects or structured arrays optimized for efficient access and manipulation.

In some examples, an output modification 525 may be used to quantify the expected impact of mitigating actions and/or interventions on a predicted outcome of a machine learning model. For example, an output modification 525 may specify a specific causal affect (e.g., a delta value) on a particular time-varying element of a node within the machine learning model. In addition, or alternatively, an output modification 525 may comprise an updated interconnection characteristics and/or weights to the edges associated with the node. For example, in an instance in which the interconnection properties of an edge are changed based on the mitigating action. In one specific example, in an instance in which the mitigating action is to close a highway between two networked locations, the weights of the edge connecting to the networked locations may be changed based on an expected decrease in traffic. An output modification 525 may provide a crucial link between causal inference models (represented by DAGs) and predictive models (such as machine learning models), allowing for the assessment of mitigating actions with respect to the predictions of a connected model.

In some embodiments, the causal DAG 530 comprises a non-terminating node 505 configured to receive a time-based output 420 from a machine learning model. The non-terminating node 505 may comprise any node of a DAG comprising at least one outgoing edge. A non-terminating node 505, for example, may be configured to receive an input, such as a time-based output 420 from a machine learning model. The causal DAG 530 may determine an output modification 525 at a terminating node 515 based on the input received at the non-terminating node 505.

In some examples, a non-terminating node 505 are comprise a node object within the data structure representing the causal DAG 530 that comprise attributes, such as incoming and/or outgoing edge connections, computational logic for processing inputs and generating outputs, and/or state information that persists across multiple evaluations of the causal DAG 530. In some examples, a non-terminating node 505 may be used to model intermediate steps in a causal chain, representing factors and/or processes that determine the effect of a mitigating action on the output modification 525. For example, in a model of disease mitigation strategies, a non-terminating node 505 may receive the number of infections for a particular area of interest, and the output modification 525 in part represents changes in the number of infections based on the mitigating action, which in turn influences disease transmission rates further down the causal chain.

The functionality of non-terminating nodes 505 extends beyond simple input-output transformations. They may incorporate domain-specific knowledge or constraints, ensuring that the causal model respects known relationships or physical limits. Some implementations may use non-terminating nodes 505 to capture feedback loops or time-delayed effects within the constraints of the acyclic graph structure.

In some embodiments, the output modification 525 is generated at a terminating node 515 of the causal DAG 530. A terminating node 515 may comprise a leaf node with no outgoing edges of a causal DAG 530. The terminating node 515 may be configured to output an output modification 525 based on the associated mitigating action. For example, a mitigating action with respect to reducing infections of a particular disease may be closing libraries. The output modification 525 may be the reduction in infections for a particular geographic location at the next time position based on the mitigating action. In some examples, the terminating node 515 may be used to produce the final output of a causal inference process within a causal DAG 530. In the context of modeling mitigating actions, they represent the ultimate effect of an intervention after accounting for all intermediate causal steps. For example, a terminating node 515 may compute the expected reduction in disease transmission rate resulting from a school closure policy, taking into account factors like reduced social contact, changes in family dynamics, potential compensatory behavior, and/or the like.

The functionality of terminating nodes 515 extends beyond simple output generation. They may incorporate uncertainty quantification, producing not just point estimates but also confidence intervals or probability distributions for the expected effects of mitigating actions. Some implementations may use terminating nodes 515 to perform sensitivity analyses, assessing how robust the predicted effects are to variations in upstream parameters or assumptions.

Alternative designs for terminating nodes 515 may comprise multi-output nodes that produce several related metrics or outcomes simultaneously. Some systems may implement adaptive terminating nodes 515 that may adjust their computational logic based on the specific context or characteristics of the input data.

FIG. 6 depicts a dataflow diagram 600 of an example connected model framework 625 in accordance with some embodiments of the present disclosure. As shown in the dataflow diagram 600, the connected model framework 625 comprises a graph neural network 605 (e.g., machine learning model 405 as described in relation to FIG. 4) and a causal DAG 530. The graph neural network 605 may comprise nodes and edges wherein the nodes represent networked locations in a networked environment and the edges quantify the strength, importance, and/or connectivity of relationships between nodes in the graph neural network 605. The graph neural network 605 may be configured to predict a time-varying element of one or more nodes in the graph neural network 605 and generate a time-based output 420 for a series of future timepoints based on the prediction. The time-based output 420 is provided to a non-terminating node (e.g., non-terminating node 505 as described in relation to FIG. 5) of the causal DAG 530 to generate an output modification 525a/525b to the graph neural network 605 based on a mitigating action associated with the causal DAG 530. The output modifications 525a/525b may comprise node modifications 525a to a node of the graph neural network (e.g., to a time-varying element) and edge modifications 525b to the edges corresponding to the node.

Utilizing the time-based output 420 and the output modifications 525a/525b, the connected model framework 625 generates a prediction sequence 615 corresponding to a predicted time-varying element at a sequence of future timepoints based on the graph neural network 605 and a mitigating action associated with the causal DAG 530. As further depicted in FIG. 6, a plurality of prediction sequences 615 may be generated, each dependent on a separate mitigating action associated with a causal DAG 530. Thus, a prediction-based action (e.g., mitigating action) may be performed based on an analysis of the set of prediction sequences 615 and one or more selection criteria. The connected model framework 625 thus improves the prediction of a time-varying element of a networked location in response to a mitigating action over a period of time, enabling improved selection of a responsive mitigating action.

In some embodiments, the computing system 101 (and/or a portion thereof) generates, using the machine learning model (e.g., graph neural network 605) within the connected model framework 625, a first time-based output 420 for a first time position in a prediction sequence for the time-based prediction, and generates a second time-based output 420 for the second time position (e.g., time positions 620) in the prediction sequence 615 based on the output modification 525a/525b and the first time-based output 420.

In some embodiments, a connected model framework 625 comprises a model framework that combines multiple different models through a connection mechanism. The connected model framework 625, for example, may comprise the machine learning model (e.g., graph neural network 605) and a connected DAG (e.g., causal DAG 530). The connection mechanism may be a link between a node within the machine learning model and another node of the causal DAG 530. For example, a terminating node 515 of the causal DAG 530 may be connected to an input node 630 of the graph neural network 605. In addition, or alternatively, a time-based output 420 of the graph neural network 605 may be connected to a non-terminating node 505 of the causal DAG 530.

In some embodiments, the connected model framework 625 may be implemented as a software architecture that manages the interaction and data flow between different model components. This may involve message passing interfaces, shared memory structures, or API-based communication between models. In computer systems, the framework may be realized as a set of interlinked objects and/or modules, each representing a different model or component. By doing so, the connected model framework 625 may combine the strengths of different modeling approaches, enabling more comprehensive and/or accurate predictions. For example, in the context of disease modeling, a connected model framework 625 may combine a graph neural network 605 for spatial disease spread prediction with a causal inference model (e.g., represented by the causal DAG 530) to assess the impact of potential mitigating actions. In any domain, the connected model frameworks 625 may enabling feedback loops and/or iterative refinement of predictions. Iterative refinement may capture complex dependencies and interactions that may not be possible with single models. Some examples may comprise adaptive mechanisms that adjust the connections or weights between models based on observed performance or changing conditions, as described herein.

As depicted in FIG. 6, the graph neural network 605 may comprise an input node 630 configured to receive the output modifications 525a/525b generated by the causal DAG 530. An input node 630, for example, may comprise a node within a graph neural network 605. It may correspond to a networked location that is connected to one or more other networked locations modeled by the graph neural network 605. The input node 630 may comprise a set of time-varying elements that is predictive of a time-based output 420 for a time-based prediction. In some examples, up to each of a set of nodes within the graph neural network 605 may comprise an input node 630 for the output modifications 525a/525b. For example, the output modifications 525a/525b may be specific to a single node (e.g., networked location) and/or applicable to up to each of the set of nodes (e.g., up to each of the networked locations) of the graph neural network 605.

In some embodiments, the connected model framework 625 is configured to generate a prediction sequence 615 comprising a time-based output 420 at one or more time positions 620. A prediction sequence 615, for example, may comprise a set of predicted time-varying elements for a time-based prediction. For instance, the prediction sequence 615 may comprise a set of time-based outputs 420 that respectively correspond to a set of future time positions 620. A time-based output 420 for a particular time position 620 may comprise a predicted time-varying element of one or more nodes of the graph neural network 605. For example, in a disease progression use case, the time-based output 420 may identify a predicted disease rate at one or more geographic locations at a particular time position 620. In some examples, the prediction sequence 615 may be used in various applications to support decision-making and planning. For instance, in epidemiology, a prediction sequence 615 of disease rates may inform resource allocation and/or mitigation strategies over time. In network throughput forecasting, prediction sequences 615 of processor utilization may inform routing strategies, and/or the like.

In some embodiments, the computing system 101 (and/or a portion thereof) updates the input node 630 with the first time-based output 420 and the output modifications 525a/525b. The graph neural network 605 may update a historical sequence associated with the input node 630 based on the time-based output 420 for a previous time position. For example, the computing system 101 may add the time-based output 420 to the historical sequence associated with the input node 630. In some embodiments, the time-based output 420, modified according to the node modifications 525a may be added to the historical sequence of the input node 630. In addition, one or more edges associated with the input node 630 may be updated according to edge modifications 525b determined by the causal DAG 530.

In some embodiments, the computing system 101 (and/or a portion thereof) generates, using the graph neural network 530, a node embedding for the input node 630 based on the historical sequence, first time-based output 420, and the output modifications 525a/525b. In some embodiments, the node embedding may be further based on subset of the set of weighted edges that is connected to the input node 630. A node embedding may comprise a vector representation of the input node 630. The embedding may capture the structural, relational, and feature-based information of the input node 630 in a way that is meaningful to the graph neural network 605. For example, the node embedding may incorporate the historical sequence associated with the input node 630, the time-varying elements associated with the input node 630, one or more edges connected to the input node 630, and other features of the input node 630 into the node embedding.

In some embodiments, the computing system 101 (and/or a portion thereof) initiates a performance of a prediction-based action based on the prediction sequence 615. A prediction-based action refers to any action performed based on predictions derived from a connected model framework 625. For example, a prediction-based action may comprise performing a mitigating action.

In some embodiments, a prediction-based action comprises a result of and/or the execution of one or more executable instructions, commands, and/or the like that is based on an output of the connected model framework. This may involve decision rules encoded in software, automated systems for resource allocation or scheduling, or interfaces to external systems that may enact real-world changes. A prediction-based action, for example, may be used to translate one or more insights, forecasts, and/or the like generated by predictive models into concrete interventions, resource allocation, and/or policy decisions. For example, in a disease management context, a prediction-based action may involve allocating additional medical resources to regions where the model predicts a surge in cases, implementing travel restrictions between high-risk areas, and/or the like. In a computer network example, a prediction-based action may involve routing data packets through an alternative network route to reduce load at a particular networked location, and/or the like.

The functionality of prediction-based actions extends beyond simple threshold-based triggers. They may involve complex decision-making processes that balance multiple objectives, consider resource constraints, account for uncertainty in predictions, and/or account for selection criteria.

In some examples, a prediction-based action may comprise adaptive strategies that adjust over time based on observed outcomes and/or updated predictions. Some systems may implement probabilistic action selection, where actions are chosen stochastically based on their predicted effectiveness. In addition, or alternatively, the computing system 101 may use reinforcement learning techniques to optimize action selection policies over time, learning from the outcomes of past actions to improve future decision-making.

In some embodiments, the computing system 101 (and/or a portion thereof) provides, based on the mitigating action, a control instruction to a networked location corresponding to an input node 630 of the set of nodes to reduce movement within the networked location. A control instruction refers to any data construct transmittable by a system of the present disclosure to perform or cause the performance of a mitigating action. For example, a control instruction may be one or more messages transmitted across a network to a networked location associated with the mitigating action. The control instructions may perform any action to cause the execution of the corresponding mitigating action. For example, a control instruction may shut down a system, send an alert, sound an alarm, notify personnel, and so on.

In some embodiments, a control instruction is provided to bridge the gap between predictive models and/or real-world interventions, translating model-derived insights into actionable commands. For example, in a pandemic management system, control instructions may be sent to local health authorities to initiate specific interventions like school closures or to logistics systems to redirect medical supplies to predicted hotspots. In a computer network, control instructions may be sent to a networked compute resource to reroute throughput, limit bandwidth, or update utilization.

In some embodiments, the prediction sequence 615 is one of a set of prediction sequences 615 respectively corresponding to the set of mitigating actions. In some examples, the computing system 101 may initiate a mitigating action in response to determining the prediction sequence from the set of prediction sequences based on selection criteria.

For example, the causal DAG 530 may be one of a set of causal DAGs. Up to each of the set of causal DAGs may be associated with a different mitigating action. In some examples, up to each of the set of causal DAGs generates different node modifications 525a and/or edge modifications 525b based on the received time-based output 420 and the characteristics of the causal DAG 530. Thus, as depicted in FIG. 6, a different graph neural network 605 may be derived from the output modifications 525a/525b over time, one associated with up to each causal DAG 530.

In some embodiments, a plurality of prediction sequences 615 is generated based on the individual time-based outputs 420 from up to each graph neural network 605. Generating a separate prediction sequence 615 based on up to each mitigating action enables a direct comparison of mitigating actions over time. A system in accordance with the present disclosure may utilize the plurality of prediction sequences 615 and various selection criteria to select a mitigating action associated with a prediction sequence 615. For example, the connected model framework 625 may generate a prediction sequence 615 for each of a set of potential mitigating actions over a predetermined time period to determine a relative change in a time-varying element of one or more nodes. The system may further analyze overall costs associated with each mitigating action, for example, implementation costs, operational costs, impact to a region or network location, and other various selection criteria associated with a mitigating action. The system may consider the overall costs against the relative change in the time-varying element for each mitigating action. A determination may be made based on various selection criteria, for example, cost savings, overall reduction in the time-varying element, reduction in the time-varying element at a particular networked location, a cost time implement a mitigating action, timeline to implement a mitigating action, relationship to other mitigating actions, and so on. In one example, a mitigating action may be selected based on overall cost savings. In such an example, a cost savings may be associated with the change in the time-varying element. The overall cost of implementing the mitigating action may be subtracted from the cost savings associated with the change in a time-varying element to determine the overall cost savings.

In some embodiments, the plurality of mitigating actions may be ranked according to one or more selection criterion. One or more mitigating actions may be automatically and/or manually selected from the ranked list. The system may transmit one or more control instructions to execute the mitigating action.

In some embodiments, the computing system 101 (and/or a portion thereof) receives a verification output corresponding to the first time-based output and updates the historical sequence of the input node based on the verification output. For example, the verification output may comprise a verification and/or modification of a time-based output 420 based on an occurrence reflective of a ground truth value for the time-based output. In response to the verification output, the computing system 101 may remove the time-based output from a prediction sequence and add the ground truth value as a new time-varying element within the historical sequence.

In some embodiments, a verification output comprise feedback data related to a time-based output 420 representing the accuracy of the time-based prediction relative to an observed outcome. For example, in an instance in which the time-based output 420 relates to a number of infections at a particular geographic location on a particular day, the verification output may be the observed number of infections at the particular geographic location on the particular day. A verification output may be determined automatically, and/or input by a user or administrator.

A verification output, for example, may comprise data structure that pairs a predicted value with an observed outcomes, along with metadata such as timestamps, location identifiers, and/or potentially measures of data quality and/or reliability. These might be stored in databases optimized for time series data, allowing for efficient retrieval and analysis of prediction accuracy over time. In some examples, a verification outputs may be used to assess the accuracy and/or reliability of time-based predictions, providing crucial feedback for model evaluation and improvement.

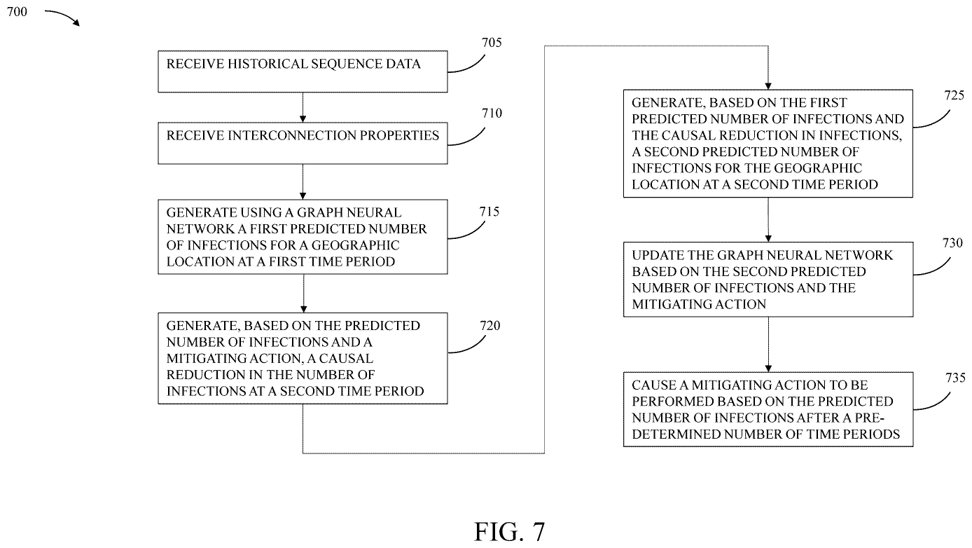

FIG. 7 is a flowchart diagram of an example process 700 for causing a mitigating action to be performed based on a prediction sequence for the time-based prediction. The flowchart diagram depicts a prediction sequence generation process utilizing a connected model framework comprising a causal DAG and a graph neural network. The process 700 may be implemented by one or more computing devices, entities, and/or systems described herein. For example, via the various steps/operations of the process 700, the computing system 101 may continuously determine a prediction sequence for a plurality of mitigating actions and initiate a mitigating action based on a cost-benefit analysis using the prediction sequence. By doing so, the process 700 improves computer functionality by improving prediction performance for interconnected systems; integrating analytical predictions based on expert analysis; and performing cross improvements between the graph neural network and the causal DAG.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 comprises, at operation 705, receiving historical sequence data. For example, the computing system 101 may receive a historical sequence for a time-based prediction.

In some embodiments, the process 700 comprises, at operation 710, receiving interconnection properties. For example, the computing system 101 may receive an interconnection attribute associated with a throughput between the networked location and a connected network location, wherein the connected network location corresponds to a connected node within the graph neural network.

In some embodiments, the process 700 comprises, at operation 715, generating using a graph neural network a first predicted number of infections for a geographic location at a first time period. For example, the computing system 101 may generate, using a machine learning model within a connected model framework, a first time-based output 420 for a first time position in a prediction sequence for the time-based prediction.

In some embodiments, the process 700 comprises, at operation 720, generating based on the predicted number of infections and a mitigating action, a causal reduction in the number of infections at a second time period. For example, the computing system 101 may generate, using a DAG of the connected model framework, an output modification for a second time position in the prediction temporal sequence and based on the first time-based output 420.

In some embodiments, the process 700 comprises, at operation 725, generating, based on the first predicted number of infections and the causal reduction in infections, a second predicted number of infections for the geographic location at a second time period. For example, the computing system 101 may generate, using the machine learning model, a second time-based output 420 for the second time position within in the prediction temporal sequence based on the output modification and the first time-based output 420.

In some embodiments, the process 700 comprises, at operation 730, updating the graph neural network based on the second predicted number of infections and the mitigating action. For example, the computing system 101 may update the input node of the graph neural network with the first time-based output 420 and the output modification. In addition, the computing system 101 may generate, using the graph neural network, a node embedding for the input node based on the historical sequence, first time-based output 420, and the output modification. Further, the computing system 101 may generate, using the graph neural network, the second time-based output 420 based on the node embedding.

In some embodiments, the process 700 comprises, at operation 735, causing a mitigating action to be performed based on the predicted number of infections after a pre-determined number of time periods. For example, the computing system 101 may initiate a performance of a prediction-based action based on the prediction temporal sequence.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising receiving, by one or more processors, a historical sequence for a time-based prediction; generating, by the one or more processors and using a machine learning model within a connected model framework, a first time-based output for a first time position in a prediction sequence for the time-based prediction; generating, by the one or more processors and using a directed acyclic graph of the connected model framework, an output modification for a second time position in the prediction sequence and based on the first time-based output; generating, by the one or more processors and using the machine learning model, a second time-based output for the second time position in the prediction sequence based on the output modification and the first time-based output; and initiating, by the one or more processors, a performance of a prediction-based action based on the prediction sequence.

Example 2. The computer-implemented method of example 1, wherein the machine learning model comprises a graph neural network and the graph neural network comprises an input node that corresponds to a terminating node of the directed acyclic graph.

Example 3. The computer-implemented method of example 2, wherein the input node comprises the historical sequence, the prediction sequence corresponds to a future state of the input node, and generating the second time-based output for the second time position in the prediction sequence comprises: updating the input node with the first time-based output and the output modification; generating, using the graph neural network, a node embedding for the input node based on the historical sequence, the first time-based output, and the output modification; and generating, using the graph neural network, the second time-based output based on the node embedding.

Example 4. The computer-implemented method of Example 3, wherein the graph neural network further comprises a set of weighted edges and the node embedding is based on a subset of the set of weighted edges that is connected to the input node.

Example 5. The computer-implemented method of Example 4, wherein the input node corresponds to a networked location, an edge of the subset of weighted edges connects the input node to a connected node based on a network connection between the networked location and a connected network location corresponding to the connected node, and an edge weight of the edge is based on a throughput between the networked location and the connected network location.

Example 6. The computer-implemented method of any of the preceding examples, wherein the directed acyclic graph comprises a non-terminating node that corresponds to the first time-based output of the machine learning model.

Example 7. The computer-implemented method of any of the preceding examples, wherein the directed acyclic graph corresponds to a mitigating action of a set of mitigating actions for the time-based prediction and the directed acyclic graph is one of a set of directed acyclic graphs that respectively correspond to the set of mitigating actions.

Example 8. The computer-implemented method of example 7, wherein the prediction sequence is one of a set of prediction sequences respectively corresponding to the set of mitigating actions and initiating the performance of the prediction-based action based on the prediction sequence comprises initiating the mitigating action in response to determining the prediction sequence from the set of prediction sequences based on selection criteria.

Example 9. The computer-implemented method of any of the preceding examples, wherein the machine learning model comprises a graph neural network that comprises an input node, the input node comprises the historical sequence, the prediction sequence corresponds to a future state of the input node, and the computer-implemented method further comprises: receiving a verification output corresponding to the first time-based output; and updating the historical sequence of the input node based on the verification output.

Example 10. The computer-implemented method of any of the preceding claims, wherein the machine learning model comprises a graph neural network comprising a set of nodes that respectively correspond to a set of networked locations and initiating the prediction-based action further comprises: providing a control instruction to a networked location corresponding to an input node of the set of nodes to reduce movement within the networked location.

Example 11. The computer-implemented method of Example 10, wherein the graph neural network further comprises a set of weighted edges and the computer-implemented method further comprises: receiving an interconnection attribute associated with a throughput between the networked location and a connected network location, wherein the connected network location corresponds to a connected node within the graph neural network; initializing an edge weight of an edge between the input node and the connected node based on the interconnection attribute; and modifying the edge weight based on the prediction-based action.

Example 12. A system comprising: one or more processors; and one or more memories storing processor-executable instructions that, when executed by the one or more processors, cause the one or more processors to perform operations comprising: receiving, by the one or more processors, a historical sequence for a time-based prediction; generating, by the one or more processors and using a machine learning model within a connected model framework, a first time-based output for a first time position in a prediction sequence for the time-based prediction; generating, by the one or more processors and using a directed acyclic graph of the connected model framework, an output modification for a second time position in the prediction sequence and based on the first time-based output; generating, by the one or more processors and using the machine learning model, a second time-based output for the second time position in the prediction sequence based on the output modification and the first time-based output; and initiating, by the one or more processors, a performance of a prediction-based action based on the prediction sequence.

Example 13. The system of example 12, wherein the machine learning model comprises a graph neural network and the graph neural network comprises an input node that corresponds to a terminating node of the directed acyclic graph.

Example 14. The system of example 13, wherein the input node comprises the historical sequence, the prediction sequence corresponds to a future state of the input node, and generating the second time-based output for the second time position in the prediction sequence comprises: updating the input node with the first time-based output and the output modification; generating, using the graph neural network, a node embedding for the input node based on the historical sequence, the first time-based output, and the output modification; and generating, using the graph neural network, the second time-based output based on the node embedding.

Example 15. The system of example 14, wherein the graph neural network further comprises a set of weighted edges and the node embedding is based on a subset of the set of weighted edges that is connected to the input node.

Example 16. The system of example 15, wherein the input node corresponds to a networked location, an edge of the subset of weighted edges connects the input node to a connected node based on a network connection between the networked location and a connected network location corresponding to the connected node, and an edge weight of the edge is based on a throughput between the networked location and the connected network location.

Example 17. The system of any of examples 12 through 16, wherein the directed acyclic graph comprises a non-terminating node that corresponds to the first time-based output of the machine learning model.

Example 18. The system of any of examples 12 through 17, wherein the directed acyclic graph corresponds to a mitigating action of a set of mitigating actions for the time-based prediction and the directed acyclic graph is one of a set of directed acyclic graphs that respectively correspond to the set of mitigating actions.

Example 19. The system of example 18, wherein the prediction sequence is one of a set of prediction sequences respectively corresponding to the set of mitigating actions and initiating the performance of the prediction-based action based on the prediction sequence comprises initiating the mitigating action in response to determining the prediction sequence from the set of prediction sequences based on selection criteria.

Example 20. One or more non-transitory computer-readable media storing processor-executable instructions that, when executed by one or more processors, cause the one or more processors to perform operations comprising: receiving, by the one or more processors, a historical sequence for a time-based prediction; generating, by the one or more processors and using a machine learning model within a connected model framework, a first time-based output for a first time position in a prediction sequence for the time-based prediction; generating, by the one or more processors and using a directed acyclic graph of the connected model framework, an output modification for a second time position in the prediction sequence and based on the first time-based output; generating, by the one or more processors and using the machine learning model, a second time-based output for the second time position in the prediction sequence based on the output modification and the first time-based output; and initiating, by the one or more processors, a performance of a prediction-based action based on the prediction sequence.

What is claimed is:

1. A computer-implemented method comprising:
receiving, by one or more processors, a historical sequence for a time-based prediction;
generating, by the one or more processors and using a machine learning model within a connected model framework, a first time-based output for a first time position in a prediction sequence for the time-based prediction;
generating, by the one or more processors and using a directed acyclic graph of the connected model framework, an output modification for a second time position in the prediction sequence and based on the first time-based output;
generating, by the one or more processors and using the machine learning model, a second time-based output for the second time position in the prediction sequence based on the output modification and the first time-based output; and
initiating, by the one or more processors, a performance of a prediction-based action based on the prediction sequence.

2. The computer-implemented method of claim 1, wherein the machine learning model comprises a graph neural network and the graph neural network comprises an input node that corresponds to a terminating node of the directed acyclic graph.

3. The computer-implemented method of claim 2, wherein the input node comprises the historical sequence, the prediction sequence corresponds to a future state of the input node, and generating the second time-based output for the second time position in the prediction sequence comprises:
updating the input node with the first time-based output and the output modification;
generating, using the graph neural network, a node embedding for the input node based on the historical sequence, the first time-based output, and the output modification; and
generating, using the graph neural network, the second time-based output based on the node embedding.

4. The computer-implemented method of claim 3, wherein the graph neural network further comprises a set of weighted edges and the node embedding is based on a subset of the set of weighted edges that is connected to the input node.

5. The computer-implemented method of claim 4, wherein the input node corresponds to a networked location, an edge of the subset of weighted edges connects the input node to a connected node based on a network connection between the networked location and a connected network location corresponding to the connected node, and an edge weight of the edge is based on a throughput between the networked location and the connected network location.

6. The computer-implemented method of claim 1, wherein the directed acyclic graph comprises a non-terminating node that corresponds to the first time-based output of the machine learning model.

7. The computer-implemented method of claim 1, wherein the directed acyclic graph corresponds to a mitigating action of a set of mitigating actions for the time-based prediction and the directed acyclic graph is one of a set of directed acyclic graphs that respectively correspond to the set of mitigating actions.

8. The computer-implemented method of claim 7, wherein the prediction sequence is one of a set of prediction sequences respectively corresponding to the set of mitigating actions and initiating the performance of the prediction-based action based on the prediction sequence comprises initiating the mitigating action in response to determining the prediction sequence from the set of prediction sequences based on selection criteria.

9. The computer-implemented method of claim 1, wherein the machine learning model comprises a graph neural network that comprises an input node, the input node comprises the historical sequence, the prediction sequence corresponds to a future state of the input node, and the computer-implemented method further comprises:
receiving a verification output corresponding to the first time-based output; and
updating the historical sequence of the input node based on the verification output.

10. The computer-implemented method of claim 1, wherein the machine learning model comprises a graph neural network comprising a set of nodes that respectively correspond to a set of networked locations and initiating the prediction-based action further comprises:
providing a control instruction to a networked location corresponding to an input node of the set of nodes to reduce movement within the networked location.

11. The computer-implemented method of claim 10, wherein the graph neural network further comprises a set of weighted edges and the computer-implemented method further comprises:
receiving an interconnection attribute associated with a throughput between the networked location and a connected network location, wherein the connected network location corresponds to a connected node within the graph neural network;
initializing an edge weight of an edge between the input node and the connected node based on the interconnection attribute; and
modifying the edge weight based on the prediction-based action.

12. A system comprising:
one or more processors; and
one or more memories storing processor-executable instructions that, when executed by the one or more processors, cause the one or more processors to perform operations comprising:
receiving, by the one or more processors, a historical sequence for a time-based prediction;
generating, by the one or more processors and using a machine learning model within a connected model framework, a first time-based output for a first time position in a prediction sequence for the time-based prediction;
generating, by the one or more processors and using a directed acyclic graph of the connected model framework, an output modification for a second time position in the prediction sequence and based on the first time-based output;
generating, by the one or more processors and using the machine learning model, a second time-based output for the second time position in the prediction sequence based on the output modification and the first time-based output; and
initiating, by the one or more processors, a performance of a prediction-based action based on the prediction sequence.

13. The system of claim 12, wherein the machine learning model comprises a graph neural network and the graph neural network comprises an input node that corresponds to a terminating node of the directed acyclic graph.

14. The system of claim 13, wherein the input node comprises the historical sequence, the prediction sequence corresponds to a future state of the input node, and generating the second time-based output for the second time position in the prediction sequence comprises:
updating the input node with the first time-based output and the output modification;
generating, using the graph neural network, a node embedding for the input node based on the historical sequence, the first time-based output, and the output modification; and
generating, using the graph neural network, the second time-based output based on the node embedding.

15. The system of claim 14, wherein the graph neural network further comprises a set of weighted edges and the node embedding is based on a subset of the set of weighted edges that is connected to the input node.

16. The system of claim 15, wherein the input node corresponds to a networked location, an edge of the subset of weighted edges connects the input node to a connected node based on a network connection between the networked location and a connected network location corresponding to the connected node, and an edge weight of the edge is based on a throughput between the networked location and the connected network location.

17. The system of claim 12, wherein the directed acyclic graph comprises a non-terminating node that corresponds to the first time-based output of the machine learning model.

18. The system of claim 12, wherein the directed acyclic graph corresponds to a mitigating action of a set of mitigating actions for the time-based prediction and the directed acyclic graph is one of a set of directed acyclic graphs that respectively correspond to the set of mitigating actions.

19. The system of claim 18, wherein the prediction sequence is one of a set of prediction sequences respectively corresponding to the set of mitigating actions and initiating the performance of the prediction-based action based on the prediction sequence comprises initiating the mitigating action in response to determining the prediction sequence from the set of prediction sequences based on selection criteria.

20. One or more non-transitory computer-readable media storing processor-executable instructions that, when executed by one or more processors, cause the one or more processors to perform operations comprising:
receiving, by the one or more processors, a historical sequence for a time-based prediction;
generating, by the one or more processors and using a machine learning model within a connected model framework, a first time-based output for a first time position in a prediction sequence for the time-based prediction;
generating, by the one or more processors and using a directed acyclic graph of the connected model framework, an output modification for a second time position in the prediction sequence and based on the first time-based output;
generating, by the one or more processors and using the machine learning model, a second time-based output for the second time position in the prediction sequence based on the output modification and the first time-based output; and
initiating, by the one or more processors, a performance of a prediction-based action based on the prediction sequence.
